(19) United States
(12) Patent Application Publication
(10) Pub. No.: US 2012/0216155 A1
(43) Pub. Date: Aug. 23, 2012

(54) CHECKING METHOD FOR MASK DESIGN OF INTEGRATED CIRCUIT

(76) Inventors: Ping-Chia Shih, Tainan City (TW); Chun-Yao Wang, Tainan City (TW); Chang-Yih Chen, Tainan City (TW); Yau-Kae Sheu, Hsinchu City (TW)

(21) Appl. No.: 13/033,582

(22) Filed: Feb. 23, 2011

(51) Int. Cl. G06F 17/50

(52) U.S. Cl. 716/52

(57) ABSTRACT

A method for checking mask design of an integrated circuit, wherein the integrated circuit includes a plurality of functional elements arranged at different positions, the method includes generating implant layer data of each functional element of the integrated circuit according to characteristics of each functional element; generating mask design data of the integrated circuit according to circuit design of the integrated circuit; generating a block diagram of the integrated circuit according to the mask design data; determining a corresponding position of the functional element in the block diagram according to the implant layer data; and comparing the implant layer data of the functional element with the mask design data at the corresponding position.

### BACKGROUND OF THE INVENTION

1. Field of the Invention

The present invention relates to a checking method for mask design of an integrated circuit, and more particularly, to a method for checking mask design of an integrated circuit according to implant layer data of each functional element of the integrated circuit.

2. Description of the Prior Art

Mask design is a necessary and important step during design and manufacturing processes of an integrated circuit. In the step of mask design, a corresponding mask pattern of each implant layer is generated according to circuit design of the integrated circuit. Thereafter, ions are implanted at the corresponding positions of the implant layers by using the mask in order to manufacture the integrated circuit. If the mask design is incorrect, such that the ions are implanted in an unwanted area, or not implanted in a targeted area, the integrated circuit may not work properly or even cannot work. Therefore, a final check is necessary in the step of mask design.

Please refer to FIG. 5, which is a flow chart 500 of current mask design processes. In step 510, generate partial mask design data of the integrated circuit according to circuit design of the integrated circuit. In step 520, perform design rule check. In step 530, generate all mask design data of the integrated circuit according to circuit design of the integrated circuit. After that, in step 540, convert data format of the mask design data of the integrated circuit. In step 550, perform design rule check. Finally, in step 560, check the mask design data of the integrated circuit by human eyes.

However, in the prior art, the method for checking the mask design is performed by human eyes. It is very time consuming, and may cause mistakes if the person checking does not pay attention. Therefore, the checking method of the prior is inefficient.

### SUMMARY OF THE INVENTION

The present invention provides a checking method for mask design of an integrated circuit, wherein the integrated circuit comprises a plurality of functional elements arranged at different positions, the method comprising generating implant layer data of each functional element of the integrated circuit according to characteristics of each functional element; generating mask design data of the integrated circuit according to circuit design of the integrated circuit; generating a block diagram of the integrated circuit according to the mask design data; determining a corresponding position of the functional element in the block diagram according to the implant layer data; and comparing the implant layer data of the functional element with the mask design data at the corresponding position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing implant layer data of each functional element of an integrated circuit of an embodiment of the present invention.

FIG. 2 is a diagram showing a block diagram of the integrated circuit of the embodiment of the present invention.

FIG. 3 is a diagram showing the corresponding positions of the functional elements in the block diagram of FIG. 2.

FIG. 4 is a flow chart of the method of the present invention for checking mask design data of the integrated circuit.

FIG. 5 is a flow chart of current mask design processes.

### DETAILED DESCRIPTION

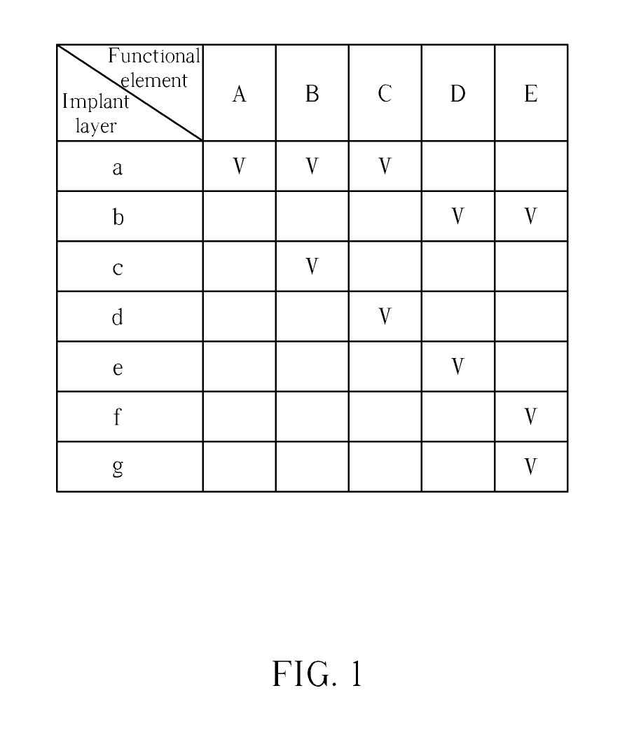

Please refer to FIG. 1, which is a diagram showing implant layer data of each functional element of an integrated circuit of an embodiment of the present invention. The implant layer data of each functional element of the integrated circuit is generated according to characteristics of each functional element. Different functional elements have different implant layers. For example, as shown in FIG. 1, functional elements A, B, C, D and E of the integrated circuit have different implant layers implanted with ions. The functional element A is implanted with ions at implant layer a. The functional element B is implanted with ions at the implant layer a and implant layer c. The functional element C is implanted with ions at the implant layer a and implant layer d. The functional element D is implanted with ions at implant layer b and implant layer e. The functional element E is implanted with ions at the implant layer b, implant layer f and implant layer g.

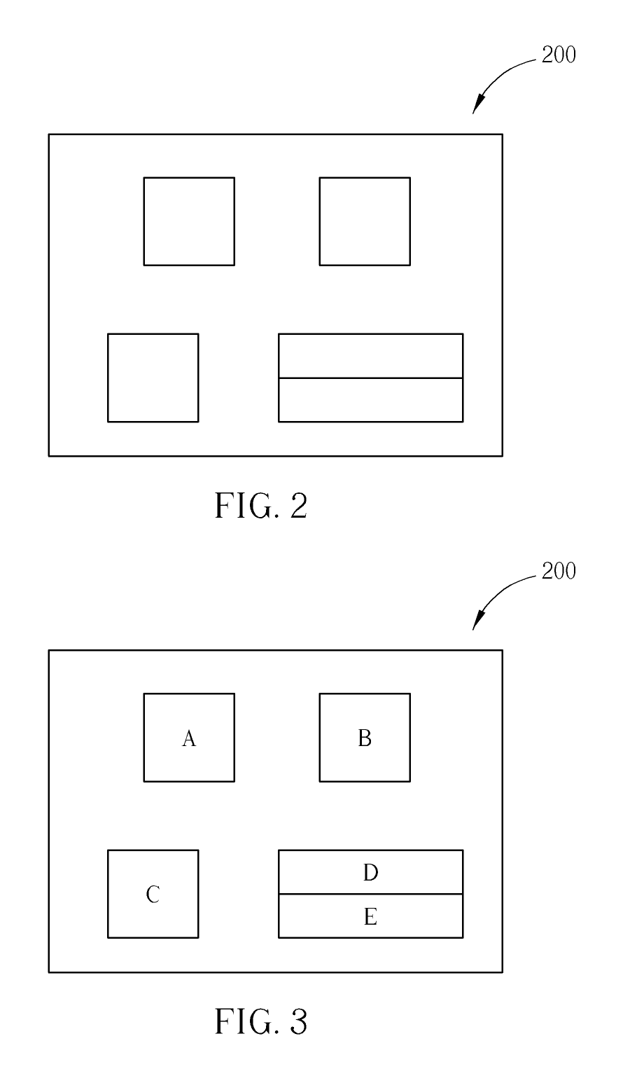

Please refer to FIG. 2, which is a diagram showing a block diagram 200 of the integrated circuit of the embodiment of the present invention. In the step of mask design, the integrated circuit is designed according to demanded functions. And, corresponding mask design data (ex. a Graphic Data System (GDS) file) of the integrated circuit is generated by logical computation of computer aided design (CAD) software according to the circuit design of the integrated circuit. The block diagram 200 of the integrated circuit is generated according to the mask design data of the integrated circuit. Each block shown in the block diagram 200 represents some functional element or some specific part.

However, the block diagram 200 of the integrated circuit generated according to the mask design data of the integrated circuit cannot specify the corresponding position of each functional element A, B, C, D or E in the block diagram 200. Therefore, the method of the present invention further determines the corresponding positions of the functional elements A, B, C, D and E in the block diagram 200 according to the implant layer data of the functional elements A, B, C, D and E. For example, please refer to FIG. 1 and FIG. 3, where FIG. 3 is a diagram showing the corresponding positions of the functional elements A, B, C, D and E in the block diagram 200 of FIG. 2. Since the functional element A is implanted with ions at the implant layer a, an implanted area of the implant layer a in the block diagram 200 is marked first. But, the functional elements B and C are also implanted with ions at the implant layer a, therefore the corresponding position of the functional element B can be specified according to an implanted area of the implant layer c in the block diagram 200, and the corresponding position of the functional element C can be specified according to an implanted area of the implant layer d in the block diagram 200. And, the corresponding position of the functional element A can be acquired by deducting the implanted area of the functional element B and C of the implant layer a in the block diagram 200. In addition, the functional element D is implanted with ions at implant layer b and implant layer e, and the functional element E is implanted with ions at the implant layer b, implant layer f and implant layer g. Thus, the method of the present invention can directly determine the corresponding position of the functional element D according to an implanted area of the implant layer e in the block diagram 200, and determine the corresponding position of the functional element E according to an implanted area of the implant layer f or g in the block diagram 200.

After determining the corresponding positions of the functional elements A, B, C, D and E in the block diagram 200, the method of the present invention further compares the implant layer data of the functional elements A, B, C, D and E with the mask design data at the corresponding positions in order to check whether the mask design date is incorrect. For example, after determining the corresponding positions of the functional element A in the block diagram 200, the method of the present invention compares the implant layer data of the functional element A with the mask design data at the corresponding position. In the mask design data, if the functional element A is implanted with ions only at the implant layer a, then the mask design data of the functional element A is correct. If the functional element A is not implanted with ions at the implant layer a, or implanted with ions at other implant layers (ex. implanted with ions at implant layer b), then the mask design data of the functional element A is incorrect. The method of the present invention checks whether the mask design date of other functional elements B, C, D and E is correct in the same way.

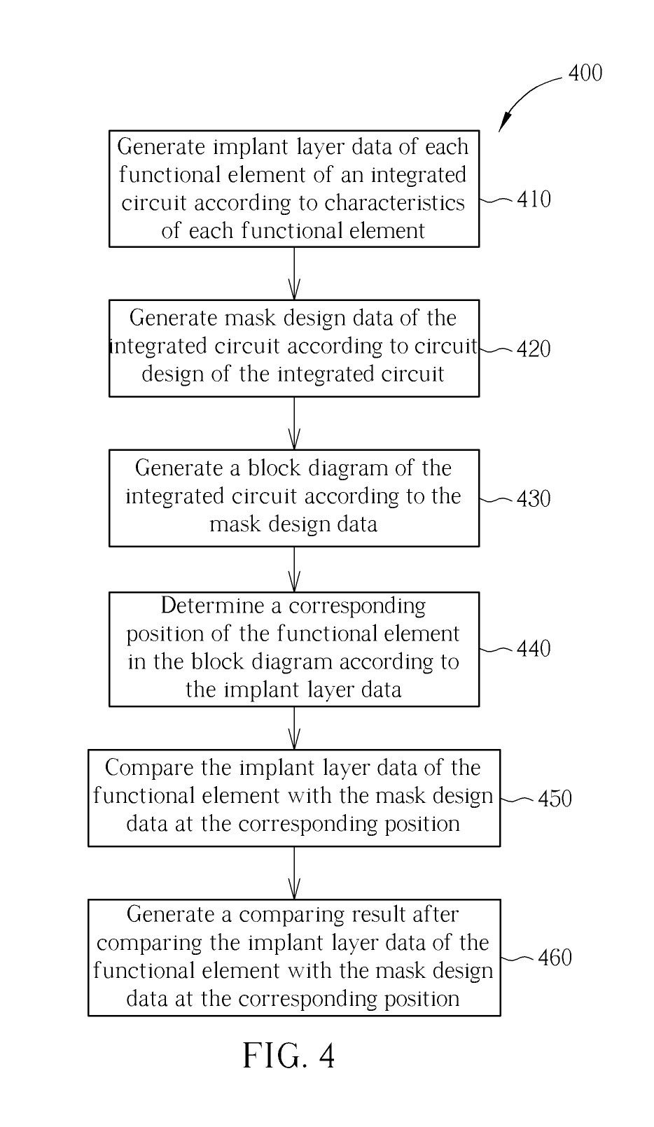

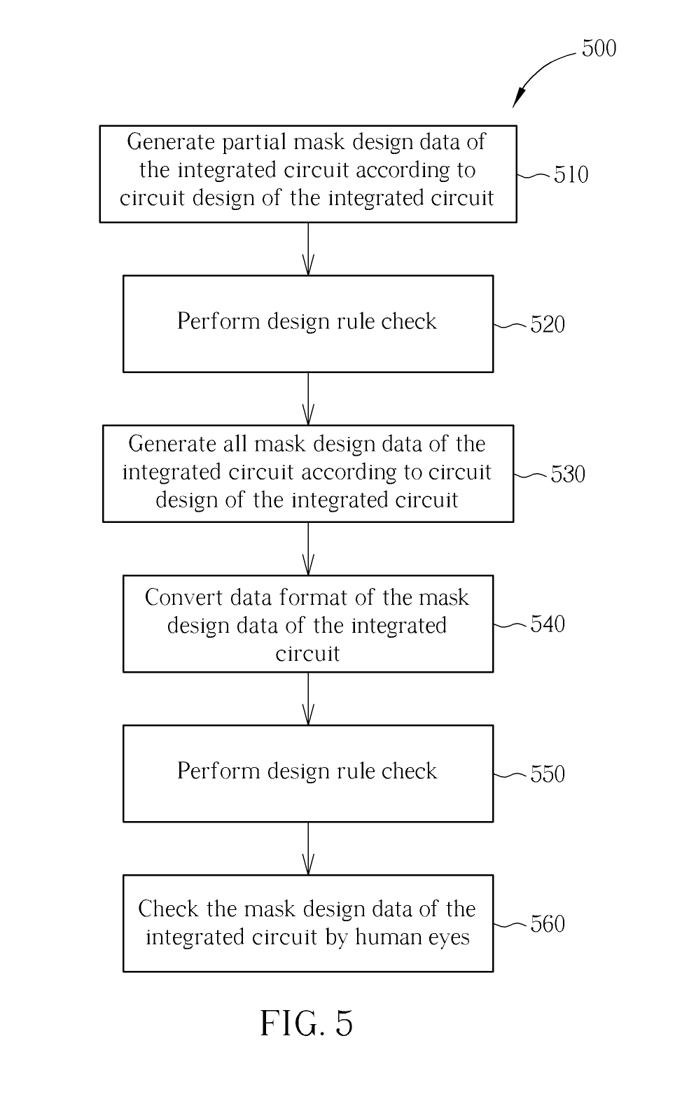

Please refer to FIG. 4, which is a flow chart 400 of the method of the present invention for checking mask design data of the integrated circuit. The flow chart 400 comprises the following steps:

Step 410: Generate implant layer data of each functional element of an integrated circuit according to characteristics of each functional element;

Step 420: Generate mask design data of the integrated circuit according to circuit design of the integrated circuit;

Step 430: Generate a block diagram of the integrated circuit according to the mask design data;

Step 440: Determine a corresponding position of the functional element in the block diagram according to the implant layer data;

Step 450: Compare the implant layer data of the functional element with the mask design data at the corresponding position; and

Step 460: Generate a comparing result after comparing the implant layer data of the functional element with the mask design data at the corresponding position.

Basically, to achieve the same result, the steps of the flowchart 400 need not be in the exact order shown and need not be contiguous, that is, other steps can be inserted between, such as performing design rule check, and converting data format of the mask design data of the integrated circuit. The above steps can be automatically performed by a computer. In addition, the comparing result of step 460 can comprise not only the information of whether the mask design data of the functional element is correct, but also the information of un-checked area of the block diagram 200 for further checking of the un-checked area.

Summarizing the above, the present invention provides a method for checking the mask design data of the integrated circuit by comparing the implant layer data of the functional element with the mask design data at the corresponding position. In contrast to the prior art, the checking method of the present invention can be automatically performed by a computer in order to check the mask date of the integrated circuit in a quick, accurate and efficient way.

Those skilled in the art will readily observe that numerous modifications and alterations of the device and method may be made while retaining the teachings of the invention.

What is claimed is:

1. A checking method for mask design of an integrated circuit, the integrated circuit comprising a plurality of functional elements arranged at different positions, the method comprising:
generating implant layer data of each functional element of the integrated circuit according to characteristics of each functional element;
generating mask design data of the integrated circuit according to circuit design of the integrated circuit;
generating a block diagram of the integrated circuit according to the mask design data;
determining a corresponding position of the functional element in the block diagram according to the implant layer data; and
comparing the implant layer data of the functional element with the mask design data at the corresponding position.

2. The method of claim 1 further comprising generating a comparing result after comparing the implant layer data of the functional element with the mask design data at the corresponding position.

3. The method of claim 1, wherein determining a corresponding position of the functional element in the block diagram according to the implant layer data is determining a corresponding position of the functional element in the block diagram according to a single implant layer of the functional element.

4. The method of claim 1, wherein determining a corresponding position of the functional element in the block diagram according to the implant layer data is determining a corresponding position of the functional element in the block diagram according to a plurality of implant layers of the functional element.

5. The method of claim 1, wherein comparing the implant layer data of the functional element with the mask design data at the corresponding position is comparing the implant layers of the functional element with the implant layers of the mask design data at the corresponding position.

6. The method of claim 1 being automatically performed by a computer.

7. The method of claim 1, wherein the mask design data of the integrated circuit is in a Graphic Data System (GDS) format.

8. The method of claim 1, wherein generating mask design data of the integrated circuit according to circuit design of the integrated circuit is generating mask design data of the integrated circuit according to circuit design of the integrated circuit by logical computation.

9. The method of claim 1 further comprising performing design rule check.

10. The method of claim 1 further comprising converting data format of the mask design data of the integrated circuit.
